(19) United States
(12) Patent Application Publication
(10) Pub. No.: US 2014/0019153 A1
(43) Pub. Date: Jan. 16, 2014

(54) DRUG MIXING PREPARATION MANAGING APPARATUS, CONTROL METHOD AND CONTROL PROGRAM

(71) Applicant: Toshiba Tec Kabushiki Kaisha, Tokyo (JP)

(72) Inventors: Shiomi MATSUI, Shizuoka (JP); Takuro MASUDA, Tokyo (JP); Shota KONISHI, Niigata (JP); Yasutsugu SASAKI, Tokyo (JP); Maki SATO, Kanagawa (JP)

(21) Appl. No.: 13/940,949

(22) Filed: Jul. 12, 2013

(30) Foreign Application Priority Data
Jul. 13, 2012 (JP) 2012-158067

(51) Int. Cl. G06F 19/00

(52) U.S. Cl. CPC G06F 19/3468
USPC 705/2

(57) ABSTRACT

A method and apparatus for managing a mixed injection preparation according to a mixed injection preparation instruction is described. The method includes obtaining a list of drugs included in a mixed injection preparation instruction, the displaying the list on a display unit. Information about a candidate drug for inclusion in the mixed injection is obtained and compared to the preparation instructions. When the candidate drug corresponds with the preparation instructions, an inspection completion symbol is displayed on the display screen in conjunction with respective drug on the list of drugs. When all drugs on the list of drugs are displayed in conjunction with a respective inspection completion symbol, an instruction is sent to a printer to print an inspection completion label.

### CROSS-REFERENCE TO RELATED APPLICATION

This application is based upon and claims the benefit of priority from Japanese Patent Application No. 2012-158067, filed Jul. 13, 2012, the entire contents of which are incorporated herein by reference.

### FIELD

Embodiments described herein relate generally to a drug mixing preparation managing apparatus, a control method, and a control program.

### BACKGROUND

In the related art, in a pharmacy of a hospital, a nurse's station in a hospital ward, or the like, a pharmacist or a nurse performs a drug mixing preparation (hereinafter, mixed injection preparation) of drugs prescribed (injection prescription) by a doctor.

When the injection mixing is performed, first, the pharmacist or the nurse sorts medicines or components that are the prescribed components with reference to the prescription, and then performs measurements (of amounts such as weight or volume), dissolution, mixing, and the like, in an appropriate order with respect to the various components.

In order to ensure the mixed injection preparation is performed correctly, the pharmacist or the nurse performs an inspection process of checking whether the various drugs to be included in the mixed injection are actually the prescribed medicines by cross referencing the labels of the drugs and prescription (injection prescription), before the mixed injection is prepared or administered.

However, there are several reasons why sorting and checking of drugs may be done erroneously or inappropriately. Specifically, inappropriate sorting may frequently occur due to various human errors such as misreading of a similar medicine name or a failure to check or confirm an expiration date before use. So, even when pharmacists or nurses are generally careful in the inspection routine occasional errors may still be made, and it is not easy to prevent the inappropriate dispensing of an erroneously prepared mixed drug preparation.

Thus, several systems that support a preparation work to reliably prevent or reduce the occurrence of preparation errors have been proposed.

For example, JP-A-2005-334056 discloses a preparation support system with a portable terminal at which various drugs are identified using a bar code read from a bar code form and the amounts of the drugs are retrieved from a data storage unit. The drug names and amounts are displayed on a display unit, and whenever a bar code on each container of the drug for each prescription for each patient is read, it may be checked whether the medicine is actually a prescribed drug on the basis of information indicated by the bar code and other information about the prescribed drugs stored in the data storage unit.

### DESCRIPTION OF THE DRAWINGS

FIG. 1 is a block diagram of a schematic configuration of a drug mixing preparation managing system.

FIG. 2 depicts a front view of a mixed injection terminal according to an embodiment.

FIG. 3 is a block diagram of a schematic configuration of a mixed injection terminal.

FIG. 4 is a process flowchart of a mixed injection terminal system according to an embodiment.

FIG. 5 is a diagram illustrating an example of an instruction content display screen.

FIG. 6 is a diagram illustrating an example of an instruction content display screen during a drug inspection process.

FIG. 7 is a diagram illustrating an example of an instruction content display screen after a drug inspection process is normally terminated.

FIG. 8 is a diagram illustrating an inspection completion label.

FIG. 9 is a diagram illustrating an example of a next inspection start instruction screen.

### DETAILED DESCRIPTION

Although it is possible to perform a check of the drugs to be included in a mixed injection preparation before preparing the mixed injection, the actual management of the preparation process and the handling of the mixed injection after preparation are generally left to a human operator and thus, it is difficult to reliably perform management of the preparation process and post-preparation handling.

A control method for managing a drug mixing preparation process includes obtaining a list of drugs included in a mixed injection preparation instruction (which may be referred to as a “prescription”), that may, for example, be generated by a doctor or pharmacist and stored in a centralized medical records server. The method includes displaying the list of drugs on a display unit, which may optionally include a touch panel. Information about a candidate drug for inclusion in the mixed injection according to the mixed injection preparation instruction is obtained, for example by reading a barcode on a container of the candidate drug. The information about the candidate drug is compared to the mixed injection preparation instruction. When the candidate drug corresponds to the mixed injection preparation instruction, an inspection completion symbol is displayed on the display unit with a drug on the list drugs. When the inspection completion symbol for each drug on the list of drugs is displayed, which indicates the inspection process for the mixed injection preparation has been successfully completed, an instruction to a printer to print an inspection completion label is sent. The method can optionally include determining whether the inspection completion label has been removed from the printer.

A drug mixing preparation managing apparatus according to an embodiment manages a drug inspection process used in a drug mixing preparation process. The apparatus includes a communication interface for receiving a mixed injection preparation instruction, and a display control unit configured to displays a list of drugs that are including in mixed injection preparation instruction on a display screen of a display unit. The apparatus further includes a processing unit, such as microcontroller unit, that is configured to compare information about a candidate drug with the mixed injection preparation instruction. The processing unit also causes the display control unit to display an inspection completion symbol (also referred to as a normal inspection pattern) in correspondence with a drug on the list of drugs when information about the candidate drug corresponds to the mixed injection preparation instruction. A printing control unit is also included. The printing control unit is configured to cause a printer to print an inspection completion label when an inspection completion symbol (also referred to as a pattern) is displayed in association with each drug on the list of drugs.

The control method may be embodied in computer software stored on a non-transitory, machine readable medium.

Next, exemplary embodiments will be described with reference to the accompanying figures.

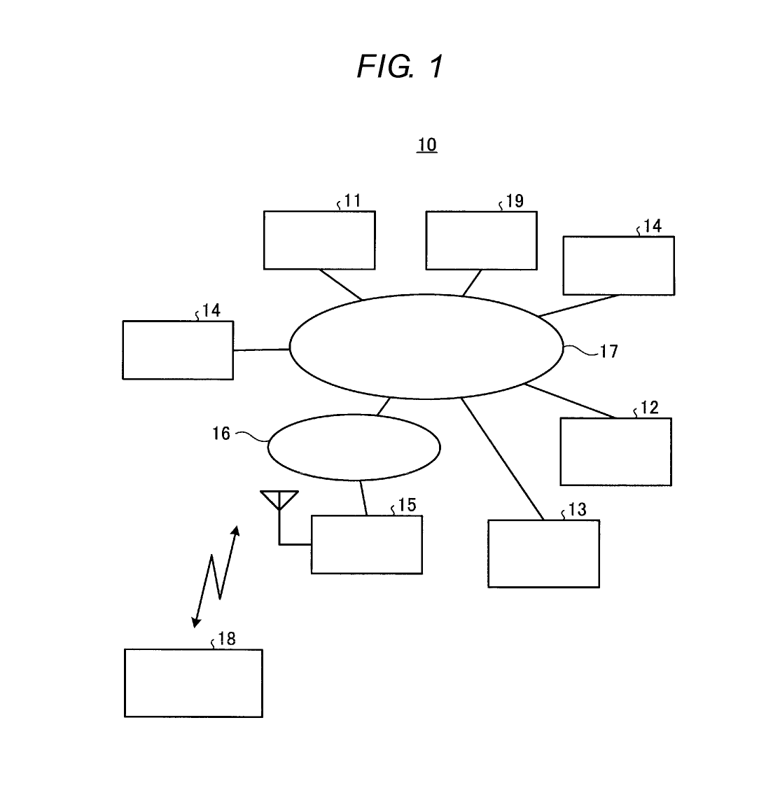

FIG. 1 is a block diagram of a schematic configuration of a drug mixing preparation managing system.

A drug mixing preparation managing system 10 includes an electronic medical record server 11 that manages and stores an electronic medical record, an information processing terminal 12, which can be used by a doctor for updating, editing, or the like of the electronic medical record, an information processing terminal 13, which can be used by a nurse for accessing the electronic medical record for reference and confirmation of information in the medical record, multiple mixed injection terminals 14 that support a mixed injection preparation, such as drug sorting on the basis of prescription information included in the electronic medical record, a mobile information processing terminal 18 that is connected to a communication network 17 through a wireless base station 15 and a public communication network 16, and a pharmacy server that manages drug payment or the like. The mobile information processing terminal 18 may be used by, for example, a doctor located at a remote location to access or update medical records. The pharmacy server 19 may be located in a pharmacy.

In the above example configuration, the electronic medical record server 11, the information processing terminal 12, the information processing terminal 13 and the mixed injection terminal 14 are connected to the communication network 17, but other networking arrangements are known in the art and are contemplated.

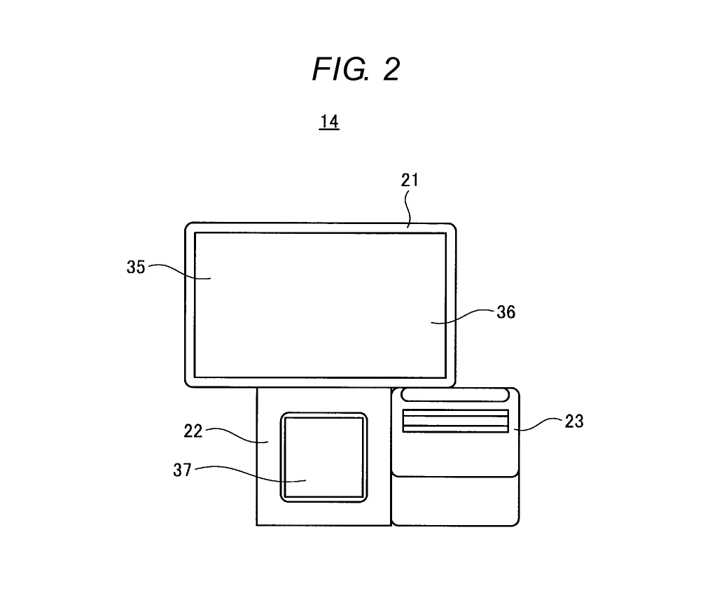

FIG. 2 is a front view depicting an appearance of an example of a mixed injection terminal.

The mixed injection terminal 14 depicted includes a touch panel display 21 through which a user performs various operations. The touch panel display 21 is capable of displaying various information such as a drug list of mixed injection targets or an inspection state of listed drugs. The mixed injection terminal 14 includes a device body 22 that has a scanner 37 configured as an object scanner that scans an ID of a nurse to verify the nurse is an authorized user, a bar code of a drug storage container to obtain information about the specific drug therein (e.g., expiration date, drug name, maximum dosage levels, etc.), and/or the drug (or drug storage container) itself to obtain information about the drug (e.g., expiration dater, drug name, maximum dosage levels, etc.) or the like, and a printer 23 for printing out various information, including possibly an inspection completed label to be applied to the mixed injection.

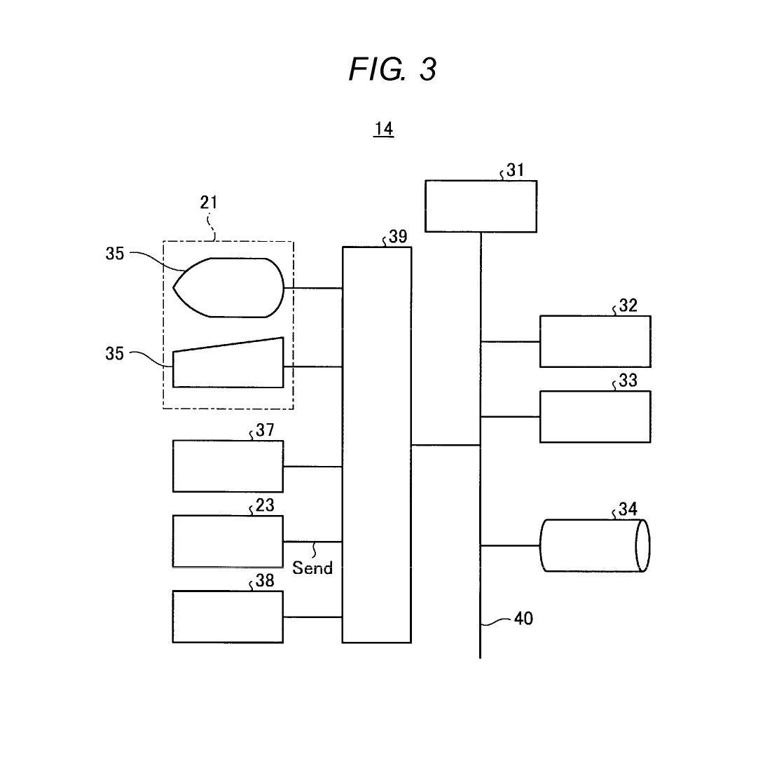

FIG. 3 is a block diagram illustrating a schematic configuration of a mixed injection terminal.

The mixed injection terminal 14 includes an MPU 31 (micro-processing unit) that controls the overall mixed injection terminal, a ROM 32 that stores various data that includes a control program in a non-volatile manner, a RAM 33 that functions as a work area and temporarily stores various data, an external storage unit 34 configured as a hard disk drive or a Solid State Drive (SSD) capable of storing large data such as a database (with e.g., drug identifications, expiration dates associated with specific drug containers, safety warnings for specific drugs, etc.), a display 35 and a touch panel 36 that form the touch panel display (display unit) 21, the scanner 37, the printer 23, and a communication interface 38 for communicating with, for example, the medical records server 11 and/or the pharmacy server 19 connected via communication network 17 (or, in some embodiments, public communication network 16).

Here, the touch panel display 21, the scanner 37, the printer 23 and the communication interface 38 are connected to a bus 40 through an input and output (I/O) 39.

The MPU 31, the ROM 32, the RAM 33 and the external storage unit 34, in addition to the communication interface 38, are connected to the bus 40.

Next, an operation of an exemplary embodiment of a mixed injection terminal 14 will be described.

Before the mixed injection is prepared, a doctor first creates an electronic medical record that includes drug prescription information (a “prescription”) using the information processing terminal 12 (or alternatively mobile information processing terminal 18) and stores the electronic medical record in the electronic medical record server 11.

In this case, information for specifying which drugs are to be included in the mixed injection and the amount of each drug are included in the prescription information (which was included in the electronic medical record). An instruction number is allocated to the drug prescription information for identification and tracking purposes. The instruction number is sent together with a mixed injection instruction to a pharmacist or a nurse who sorts the drugs of the mixed injection or is printed as a symbol code, such as a bar code, on a mixed injection instruction sheet to be provided to the pharmacist or nurse responsible for preparing the mixed injection according to the prescription information. Alternatively, the nurse or pharmacist may simply be provided with the instruction number (or corresponding barcode), which they may then use to access the details of the mixed injection preparation that has been prescribed.

Now, an example sorting process suitable for the preparation of mixed injection drugs will be described.

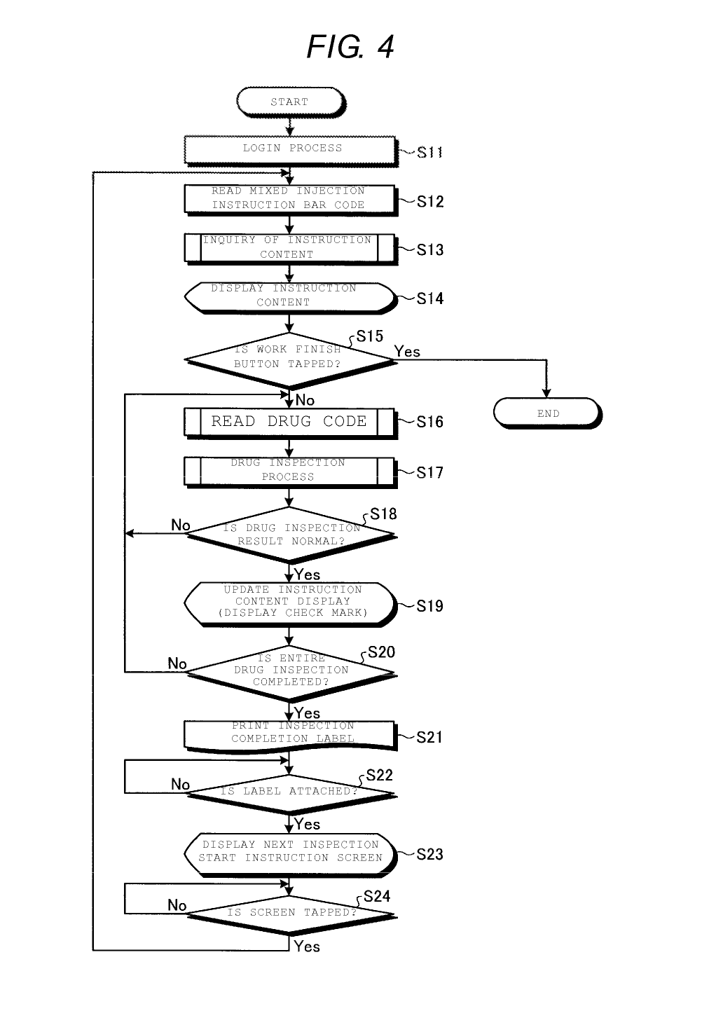

FIG. 4 is a processing flowchart of a mixed injection terminal operation according to an exemplary embodiment.

In the display 35 of the touch panel display 21 of the mixed injection terminal 14, a login screen is displayed in an initial state.

Accordingly, an operator of the mixed injection terminal 14 performs a login process according to a predetermined procedure (for example, causes an ID card to be read, or inputs an ID number) (step S11).

If the operator is authenticated by the login process, the MPU 31 of the mixed injection terminal 14 displays a screen that prompts reading of a mixed injection instruction bar code on a display screen of the display 35, and thus, the operator holds the mixed injection instruction bar code in front of the scanner 37 to cause the mixed injection instruction bar code to be read (step S12).

Here, the mixed injection instruction bar code has been previously generated and issued by the electronic medical record server 11 or the pharmacy server 19.

Thus, if the operator causes the scanner 37 to read the mixed injection instruction bar code, the MPU 31 of the mixed injection terminal 14 makes an inquiry about instruction content to the electronic medical record server 11 or the pharmacy server 19 through the communication interface 38 and the communication network 17 (step S13).

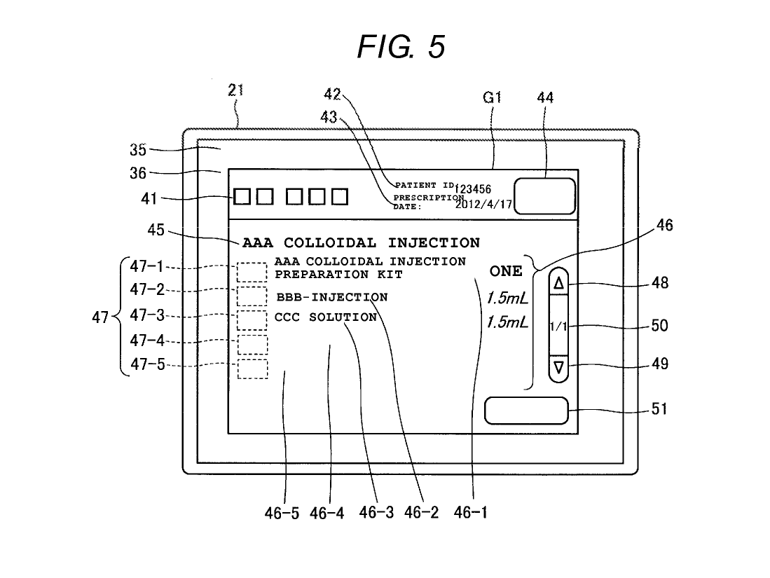

Subsequently, the MPU 31 of the mixed injection terminal 14 displays an instruction content display screen G1 (depicted in FIG. 5) on the basis of obtained list of the drugs in the mixed injection preparation (step S15).

FIG. 5 is a diagram illustrating a display example of an instruction content display screen.

The instruction content display screen G1 includes a patient name display area 41, a patient ID display area 42, a prescription date display area 43, a bar code re-reading button 44, a mixed injection instruction name display area 45, a mixed injection target drug list display area 46, an inspected mark (inspection completion symbol) display area 47, a mixed injection target drug list up-scroll button 48, a mixed injection target drug list down-scroll button 49, a display page information display area 50, and a work finish button 51.

The patient name display area 41 is an area where a name of a patient who is to receive the mixed injection is displayed.

The patient ID display area 42 is an area where an ID for specifying the patient to receive the mixed injection is displayed.

The prescription date display area 43 is an area where a date corresponding to when the prescription was issued is displayed.

The bar code re-reading button 44 is a button that when tapped by an operator cause the scanner 37 to re-read the mixed injection instruction bar code, which may be useful if the wrong bar code has been mistakenly read in an initial instance, for example, or is tapped by the operator when the process of step S12 of reading the mixed injection instruction bar code is to be performed.

The mixed injection instruction name display area 45 is an area where a mixed injection instruction name for easily grasping the mixed injection instruction content is displayed.

The mixed injection target drug list display area 46 is an area where the list of the drugs that are to be included in mixed injection is displayed. Here, the display area 46 includes five mixed injection target drug display areas 46-1 to 46-5, which each respectively display a drug name from the mixed injection target drug list, provided per page.

Further, the drug names displayed in the mixed injection target drug display areas 46-1 to 46-5 may vary in a display state such that the display state indicates whether the target drug is “before-inspection,” (that is, no inspection has been made yet) “abnormal inspection” (that is, the inspection process has found something amiss with the target drug), and “normal inspection” (that is, the inspection process has confirmed the drug is suitable for inclusion in the mixed injection). Since the example shown in FIG. 5 corresponds to the case of “before-inspection,” the drug names are expressed in italics (italic typeface) to distinguish inspection states, but various typefaces or other indicators such as a reversed display or a different color compared with the case of normal inspection may be implemented.

In the inspected mark (inspection completion symbol) display area 47, five inspected mark display areas 47-1 to 47-5 where check icons (checkmarks) are respectively displayed when an inspection instructed for each of the corresponding mixed injection target drug display areas 46-1 to 46-5 is normally performed. Accordingly, in the case of before-inspection of the instructed drugs or and abnormal inspection, nothing is displayed in this example.

The mixed injection drug list up-scroll button 48 is a button for scrolling the mixed injection drug list upward with every tap when the mixed injection target drug list extends over multiple pages. In the case of the example in FIG. 5, since the mixed injection target drug list is on a single page, the mixed injection drug list up-scroll button 48 enters a grayed-out display state, which is used here as an example to represent a non-operable state.

The mixed injection drug list down-scroll button 49 is a button for scrolling the mixed injection drug list downward with every tap when the mixed injection target drug list extends over plural pages. In the case of the example in FIG. 5, since the mixed injection target drug list is on a single page, the mixed injection drug list down-scroll button 49 enters a gray-out display state, which is used here as an example to represent a non-operable state.

The display page information display area 50 displays a current display page number of the mixed injection target drug list and all pages thereof in the format of display page number/all pages. That is, since the case of FIG. 5 displays “1/1”, the current display page number is 1, and all page number is 1.

The work finish button 51 is a button tapped by an operator when the drug inspection work is finished.

Returning again to the overall operation of the mixed injection terminal 14, when a state where the instruction content display screen G1 in FIG. 5 is displayed, the MPU 31 determines whether the work finish button 51 is tapped (step S15).

In the determination in step S15, if the work finish button 51 is tapped (Yes in step S15), the drug inspection work is terminated.

On the other hand, in the determination of step S15, if the work finish button 51 is not tapped (No in step S15), the MPU 31 proceeds to a drug code reading process (step S16).

In a state where the instruction content display screen G1 in FIG. 5 is displayed, in order to cause an operator to perform the inspection process of the drugs of the mixed injection targets, by causing the scanner 37 to read, for example, a bar code symbol, such as an GS1 data bar (GS1-RSS code: ethical drug bar code), affixed/printed on a container or a cover of a drug on mixed injection target drug list, the drug code reading process is performed (step S16).

Thus, the MPU 31 performs a drug inspection process on the basis of the content of the drug list and the drug code (e.g., the GS1 data bar) read in step S16 (step S17). That is, the MPU 31 compares the drug corresponding to the read drug code (e.g., the GS1 data bar on the candidate drug) with the drug included/identified in the mixed injection instruction (the prescription).

Thus, the MPU 31 determines whether the drug inspection result is normal or not (step S18). That is, it is determined whether the candidate drug corresponding to the read drug code (e.g., the GS1 data bar) is a drug included in the mixed injection preparation instructions, that is, whether the read drug code corresponds to a drug on the mixed injection target drug list for which the inspection result is not yet normal.

In the determination of step S18, if the drug inspection result is not normal (No in step S18), the procedure proceeds to step S16 again, and thereafter, the same operations are performed.

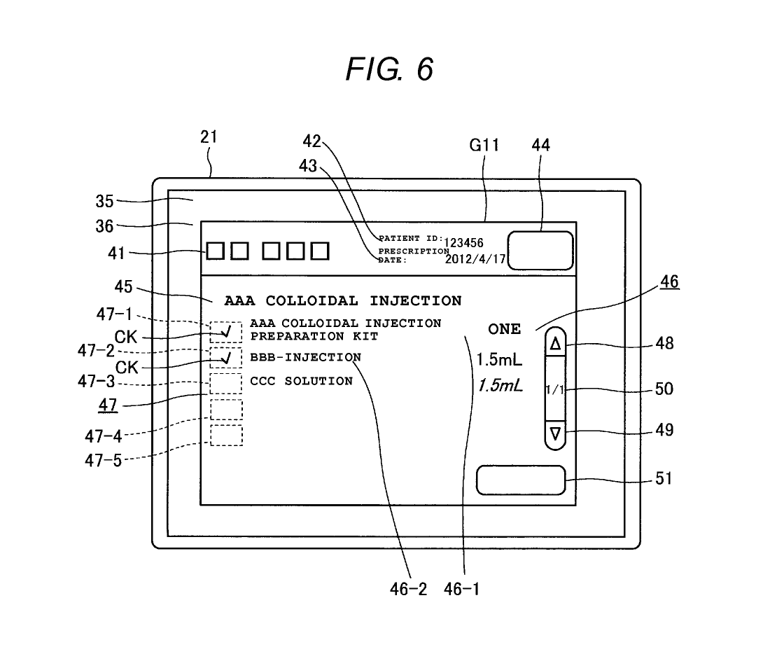

FIG. 6 is a diagram illustrating a display example of an instruction content display screen displayed during the drug inspection process.

In the determination of step S18, if the drug inspection result is normal (Yes in step S18), the MPU 31 displays a check icon (checkmark) CK in the inspected mark display area 47 corresponding to the drug of the read drug code, as shown in FIG. 6 (step S19).

In FIG. 6, an instruction content display screen G11 at a point of time when drug inspection results of two types of drugs of a drug name “AAA colloidal injection preparation kit” and a drug name “BBB-injection” are normal (during the drug inspection process) is shown.

That is, a checkmark CK is displayed in the inspected mark display area 47-1 corresponding to the drug name “AAA colloidal injection preparation kit” displayed in the mixed injection target drug display area 46-1, and the checkmark CK is displayed in the inspected mark display area 47-2 corresponding to the drug name “BBB-injection” displayed in the mixed injection target drug display area 46-2.

Subsequently, the MPU 31 determines whether the entire drug inspection is to be terminated (step S20). That is, the MPU 31 determines whether the checkmark CK is displayed in all the inspected mark display areas 47-1 to 47-X (X is the total number of all drugs on the mixed injection preparation instruction list) of the inspected mark display area 47 corresponding to the entire drugs displayed in the mixed injection target drug display area 46-1.

In the stage of the process depicted in FIG. 6, since the inspected mark display area 47-3 corresponding to a drug name “CCC solution” displayed in the mixed injection target drug display area 46-3 is not yet checked (indicating the inspection process has not yet been completed normally for this drug), the procedure proceeds to step S16 again, and thereafter, the same operations are performed.

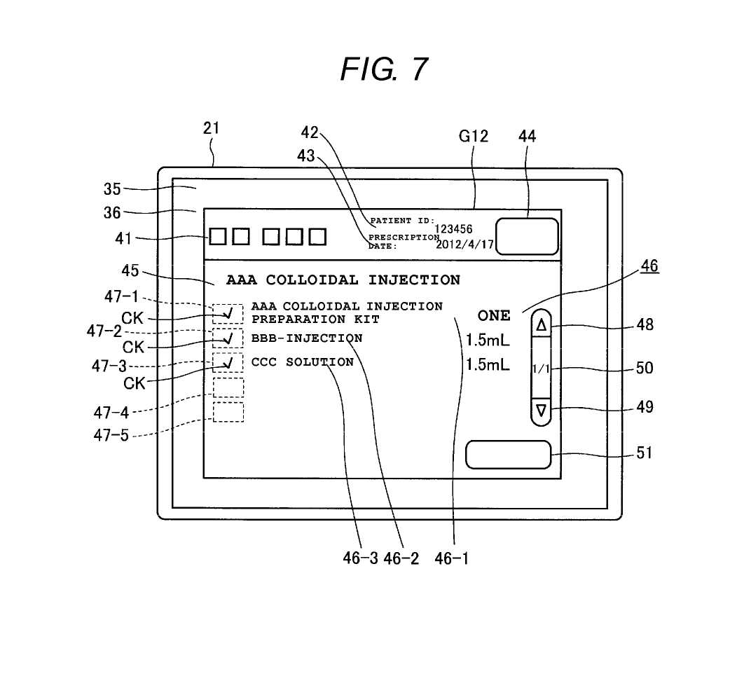

FIG. 7 is a diagram illustrating a display example of an instruction content display screen after the drug inspection process is normally terminated.

In FIG. 7, an instruction content display screen G12 at a point of time when drug inspection results of all three of drugs (the drug name “AAA colloidal injection preparation kit”, the drug name “BBB-injection”, and the drug name “CCC solution”) are normal (after the drug inspection is normally terminated) is shown.

That is, the checkmark CK is displayed in the inspected mark display area 47-1 corresponding to the drug name “AAA colloidal injection preparation kit” displayed in the mixed injection target drug display area 46-1, the checkmark CK is displayed in the inspected mark display area 47-2 corresponding to the drug name “BBB-injection” displayed in the mixed injection target drug display area 46-2, and the checkmark CK is displayed in the inspected mark display area 47-3 corresponding to the drug name “CCC solution” displayed in the mixed injection target drug display area 46-3.

In this state, the MPU 31 determines whether the entire drug inspection process is terminated (step S20), but in this stage, since the checkmark CK is displayed in all the inspected mark display areas 47-1 to 47-X (X is the total number of all drugs on the mixed injection preparation instruction) of the inspected mark display area 47 corresponding to the entire drugs displayed in the mixed injection target drug display area 46-1 (Yes in step S20), the MPU 31 controls the printer 23 to print an inspection completion label (step S21).

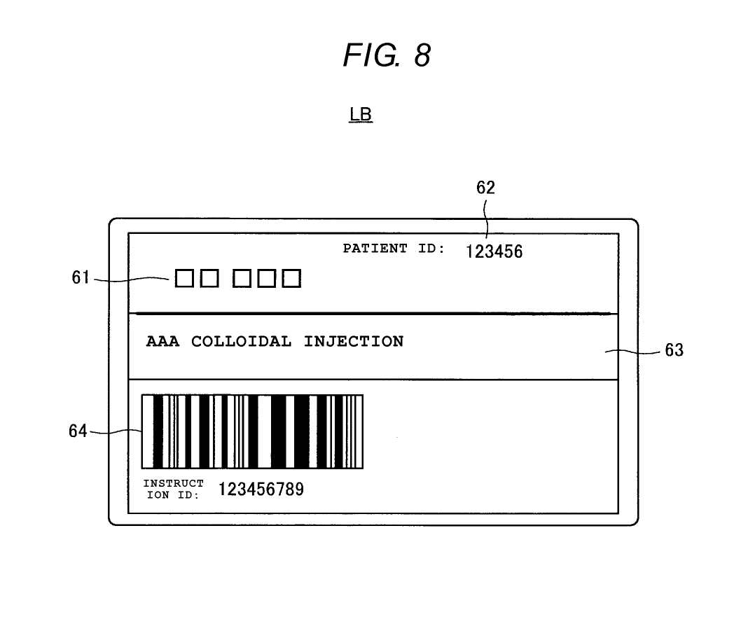

FIG. 8 is a diagram illustrating an example of an inspection completion label.

An inspection completion label LB is a label to be attached to the mixed injection after preparation is completed. The inspection completion label LB can be used for a so-called 3-point check. Specifically, the inspection completion label LB includes a patient name display area 61, a patient ID display area 62, a prescription outline display area 63, and an instruction ID display area 64.

The patient name display area 61 is an area where a name of a patient to be given the mixed injection is printed.

The patient ID display area 62 is an area where an ID number for specifying the patient that is to be given the mixed injection is printed.

The prescription outline display area 63 is an area where a prescription outline (e.g., a summary or summarizing information) of the mixed injection, that is, an outline of the components of the mixed injection is printed. For example, the prescription outline might include only pharmacologically important components of the mixed injection and/or overall dosage levels of these components.

The instruction ID display area 64 is an area where an instruction (prescription) ID that corresponds to specific instruction content from the stored medical records is printed as a code symbol (e.g., in FIG. 8, a bar code) capable of being read by the scanner 37 or the like.

In some embodiments, the printer 23 may include a sensor (such as an optical sensor, electrostatic sensor, micro-switch, or the like) that detects that the inspection completion label LB has been removed from the printer 23.

The printer 23 can be configured to output an output completion signal “Send” when it is detected that the inspection completion label LB has been removed from the printer 23.

Accordingly, the MPU 31 detects that the output completion signal “Send” is output from the printer 23 through the input and output I/O 39, and if the output completion signal “Send” is received by the MPU 31, the MPU 31 causes a screen to display on the display screen of display 35 that prompts a start of the next inspection process (step S23).

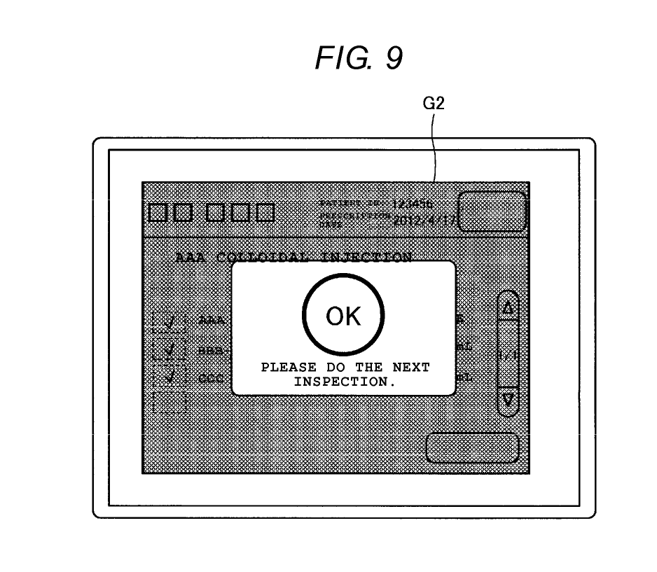

FIG. 9 is a diagram illustrating a display example of the next inspection start instruction screen.

As shown in FIG. 9, a message “Please do the next inspection.” and a mark “OK” are displayed in a large size on the next inspection start instruction screen G2.

Then, the MPU 31 determines whether the screen is tapped by an operator while the next inspection start instruction screen G2 is being displayed (step S24).

In the determination in step S24, if the screen is not tapped by the operator while the next inspection start instruction screen G2 is being displayed (No in step S24), the MPU 31 enters a standby state.

In the determination in step S24, if the screen is tapped by the operator while the next inspection start instruction screen G2 is being displayed (Yes in step S24), the procedure proceeds to step S12 again, and inspection is started according to the next mixed injection instruction.

As described above, according to the present exemplary embodiment, when the drug mixing preparation (mixed injection) is performed, it is possible to reliably perform the inspection process, and to prescribe the drug after mixing preparation in which the inspection process is reliably performed to the patient.

In the above description, a configuration is provided in which the MPU 31 detects that the output completion signal “Send” is input from the printer 23 through the input and output I/O 39, and if the output completion signal “Send” is input, the MPU 31 displays the screen that prompts the start of the next inspection process on the display screen of the display 35. In this regard, a configuration may be provided in which it is possible to display the screen that prompts the start of the next inspection process on the display screen of the display 35 by reading an instruction ID code symbol that specifies an instruction content of an inspection target, which is printed in an instruction ID display area 73, using the scanner 37.

With such a configuration, it is possible to reliably determine that the inspection process is performed, to thereby secure process reliability.

In the above description, the checkmark CK that is an icon as an inspection normal symbol is described, but instead, it is possible to use other indicators, such as a text (for example, X mark) as the inspection normal symbol.

In the above example embodiment, a case where the printer is incorporated into the drug mixing preparation managing apparatus is described, but the disclosure is not so limited and an external printer may be used in other embodiments.

In the certain described embodiments, the mixed injection terminal 14 is configured as an information processing apparatus (computer) disposed in a fixed location, but the disclosed mixed injection terminal is not limited thereto, and a mixed injection terminal 14 may be configured as a portable information processing apparatus such as a mobile tablet-type information processing apparatus, a notebook-type information processing apparatus, or a smart phone.

In this case, a printer may be connected by a wireless LAN or the like may be used as the printer.

In the above examples, as the code read in the drug code reading process, a bar code that is called a GS1 data bar has been cited as an example, but the code is not limited to this barcode type, or any specific barcode type, and the code associated with the drugs on the prescription list may be supplied by an RFID (radio frequency identification) tag, or the like.

In the above description, a case where the mixed injection terminal 14 is used in a hospital is described as an example, but other locations are contemplated and the specific location described in the examples is not intended as a limitation, and the mixed injection terminal 14 may be similarly applied to any field where it is necessary to perform mixing preparations, such as a preparation pharmacy, a research laboratory, or a diagnostic laboratory.

The control program executed in the drug mixing preparation managing apparatus of the present disclosure can be recorded for provision on a non-transitory, computer-readable recording medium such as a CD-ROM, a Flexible (floppy) Disk (FD), a CD-R or a Digital Versatile Disk (DVD) as a file of an installable format or an executable format.

Further, the control program executed in the drug mixing preparation managing apparatus of the present disclosure may be stored in a computer connected to a network such as the Internet and may be downloaded through the network or run remotely. Further, the control program executed in the drug mixing preparation managing apparatus of the present disclosure may be provided or distributed through the network such as the Internet.

Further, the control program executed in the drug mixing preparation managing apparatus of the present disclosure may be provided by being installed in a ROM or the like in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control method for managing a drug mixing preparation process, comprising:
obtaining a list of drugs included in a mixed injection preparation instruction;
displaying the list of drugs on a display unit;
obtaining information about a candidate drug for inclusion in a mixed injection preparation according to the mixed injection preparation instruction;
comparing obtained information about the candidate drug to the mixed injection preparation instruction;
displaying an inspection completion symbol on the display unit in correspondence with a drug on the list of drugs when the information about the candidate drug corresponds to the mixed injection preparation instruction; and
sending an instruction to a printer to print an inspection completion label when an inspection completion symbol is displayed in respective correspondence with each drug on the list of drugs.

2. The control method of claim 1, wherein obtaining information about the candidate drug comprises reading a barcode associated with the candidate drug.

3. The control method of claim 2, wherein the obtained information about the candidate drug includes a manufacturing lot number of the candidate drug.

4. The control method of claim 1, wherein the obtained information about the candidate drug includes an expiration date of the candidate drug.

5. The control method of claim 4, wherein comparing information about the candidate drug to the mixed injection preparation instruction includes a comparison of expiration date of the candidate drug with a current date.

6. The control method of claim 1, further comprising:
placing the inspection completion label on the mixed injection preparation.

7. The control method of claim 1, wherein obtaining the list of drugs included in the mixed injection preparation instruction includes reading a bar code associated with the mixed injection preparation instruction.

8. The control method of claim 7, wherein the mixed injection preparation instruction is stored on a network storage device.

9. The control method of claim 1, wherein the inspection completion symbol is a checkmark.

10. The control method of claim 1, further comprising:
determining whether the inspection completion label has been removed from the printer.

11. An apparatus for managing a drug mixing preparation, the apparatus comprising:
a communication interface for receiving a mixed injection preparation instruction;
a display control unit configured to control a display unit so as to display thereon a list of drugs included in the mixed injection preparation instruction;
a processing unit configured to compare information obtained about a candidate drug for inclusion in a mixed injection preparation with the mixed injection preparation instruction and to cause the display control unit to display an inspection completion symbol on the display unit in correspondence with a drug on the list of drugs when the information about the candidate drug corresponds to the mixed injection preparation instruction; and
a printing control unit configured to cause a printer to print an inspection completion label when an inspection completion symbol is displayed in respective correspondence with each drug on the list of drugs.

12. The apparatus according to claim 11, wherein the printing control unit is configured to send an output completion signal when the inspection completion label is removed from the printer.

13. The apparatus of claim 12, wherein the display control unit is configured to control the display unit to display a screen for prompting a start of the next inspection process when the output completion signal is sent by the printing control unit.

14. The apparatus according to claim 11, wherein the display control unit is configured to control the display unit such that a display state of each drug on the list of drugs is changed when an inspection process is normally performed for the drug.

15. The apparatus according to claim 14, wherein the change in display state is a change a typeface displayed on the display unit.

16. The apparatus according to claim 11, further comprising a barcode reader configured to uniquely identify the candidate drug.

17. The apparatus according to claim 11, wherein the display unit comprises a touch panel.

18. A non-transitory computer readable medium storing a computer program for controlling an apparatus to carry out a method for managing a drug mixing preparation, said method comprising the steps of:
obtaining a list of drugs included in a mixed injection preparation instruction;
displaying the list of drugs on a display unit;
obtaining information about a candidate drug for inclusion in a mixed injection preparation in accordance with the mixed injection preparation instruction;
comparing obtained information about the candidate drug to the mixed injection preparation instruction;
displaying an inspection completion symbol on the display unit in correspondence with a drug on the list of drugs when the information about the candidate drug corresponds to the mixed injection preparation instruction; and
sending an instruction to a printer to print an inspection completion label when an inspection completion symbol is displayed in respective correspondence with each drug on the list of drugs.

19. The non-transitory computer readable medium of claim 18, wherein the step of obtaining information about the candidate drug comprises reading a barcode associated with the candidate drug.

20. The non-transitory computer readable medium of claim 18, the steps of the method further comprising:
determining whether the inspection complete label has been removed from the printer.

21. The non-transitory computer readable medium of claim 18, wherein the step of obtaining the list of drugs included in the mixed injection preparation instruction includes querying a remote server.
